(19) United States
(12) Patent Application Publication
(10) Pub. No.: US 2021/0017065 A1
(43) Pub. Date: Jan. 21, 2021

(54) APPARATUS AND METHODS OF PROCESSING A GLASS SHEET

(71) Applicant: CORNING INCORPORATED, CORNING, NY (US)

(72) Inventors: James William Brown, Painted Post, NY (US); Hsien Hui Chen, Kaohsiung City (TW); Tzu-Yen Kao, Taichung City (TW); Ping Chun Liang, Hsinchu-si (TW); Weiwei Luo, Painted Post, NY (US); Naiyue Zhou, Painted Post, NY (US)

(21) Appl. No.: 17/043,114

(22) PCT Filed: Apr. 1, 2019
(86) PCT No.: PCT/US2019/025111

§ 371 Date: Sep. 29, 2020

Related U.S. Application Data
(60) Provisional application No. 62/651,436, filed on Apr. 2, 2018.

(51) Int. Cl. C03B 35/22; C03B 33/02; B65G 49/06

(52) U.S. Cl. CPC C03B 35/22; C03B 33/0215; B65G 2249/04; C03B 2225/02; B65G 49/063

(57) ABSTRACT

Apparatus and methods for processing a glass sheet are disclosed. A first plurality of fluid outlets are directed at a first major surface of a glass sheet and a second plurality of fluid nozzles are directed at a second major surface of the glass sheet. The first plurality of fluid nozzles and second plurality of fluid nozzles are spaced apart at an adjustable gap, and the gap can be increased or decreased during processing the glass sheet. The apparatus and methods can be used to reduce bow in a glass sheet.

### CROSS-REFERENCE TO RELATED APPLICATION

This application claims the benefit of priority under 35 U.S.C. § 119 of U.S. Provisional Application Ser. No. 62/651,436 filed on Apr. 2, 2018, the content of which is relied upon and incorporated herein by reference in its entirety.

### BACKGROUND

Glass sheets are commonly fabricated by flowing molten glass to a forming body whereby a glass ribbon may be formed by a variety of ribbon forming processes including, float, slot draw, down-draw, fusion down-draw, up-draw, or any other forming processes. The glass ribbon from any of these processes may then be subsequently processed to remove edge beads and divided by mechanical scoring and breaking to provide one or more glass sheets suitable for further processing into a desired application, including but not limited to, a display application. For example, the one or more glass sheets can be used in a variety of display applications, including liquid crystal displays (LCDs), electrophoretic displays (EPD), organic light emitting diode displays (OLEDs), plasma display panels (PDPs), or the like. Glass sheets may be transported from one location to another. The glass sheets may be transported with a conventional support frame designed to secure a stack of glass sheets in place. Moreover, interleaf material can be placed between each adjacent glass sheet to help prevent contact between, and therefore preserve, the pristine surfaces of the glass sheets.

Glass sheets processed after separation from an as formed ribbon can attract undesired glass chips and particles formed during mechanical scoring and breaking processes used for ribbon cutoff and to remove the edge beads. These glass chips and particles can become bonded to the glass surface causing the entire sheet to be unacceptable for many display applications. Glass chips and particles, commonly referred to as adhered glass or ADG, create defects in display devices. One method to resolve ADG issue would be to remove the glass chips/particles by cleaning the glass surface before these actually bond. Cleaning the glass after the ribbon cut off and bead removal processes can be a challenge since the glass is still hot and not flat. Glass shape variation, also referred to as bow, has been measured to be greater than 20 mm due to thermal gradients across the sheet and from the top to bottom of the sheet. For example, a glass shape variation or bow of 25 mm in a major plane (z-plane) of a glass sheet over 1.5 meters in a direction transverse to the major plane (x-direction or y-direction) has been observed. In addition to shape variation, the carrying method to transport glass sheets, which is purposely compliant to prevent potential breakage of the glass due to over constraint, lacks precision. This compliant handling results in poor precision of the glass plane during transferring during after the glass sheet has been scored and broken into sheets after forming. Cleaning processes typically rely on the glass sheet being presented to the cleaning tools such as high pressure nozzles, brushes and the like in a fixed plane so the applied force is consistent during cleaning. Maintaining the glass in a fixed plane is also important during drying, since sheet glass drying relies on water removal through force of the air from an air knife directed across the glass major surface. Changes in the elevation, gap between the air knife and the glass major surface being dried prevent consistent drying across the major surface. Also, localized forces due to high pressure cleaning or drying of a shaped sheet easily create force imbalance between the A and B sides (front major surface and back major surface) as well as left to right differences. These force differences can cause the glass sheet to become unstable, vibrate during cleaning potentially causing the sheet to contact the cleaning equipment. Contact of the glass sheet with the cleaning or drying equipment will result in unacceptable scratches or chips also making the glass unusable.

Accordingly, it would be desirable to provide apparatus and methods that position and convey a glass sheet into the cleaning system with sufficient precision to align the glass to a predefined glass plane which is on plane with a motion system moving the glass and allows position of the cleaning tools within a fixed distance offset from the glass major surface. This would permit equal forces to the A & B surfaces (front and back) so non-contact guidance of the glass sheet can occur without the creation of defects such as scratches or chips to the pristine surfaces produced by glass forming.

### SUMMARY

The present disclosure relates generally to glass sheet processing apparatus, systems and methods. In a first embodiment, a glass sheet processing apparatus comprises a first plurality of fluid outlets adjustably spaced apart from a second plurality of fluid outlets and defining a gap sized to pass a glass sheet comprising a first major surface and a second major surface defining a thickness, the first plurality of fluid outlets directed at the first major surface and the second plurality of fluid outlets directed at the second major surface when the glass sheet is disposed in the gap; a pressurized fluid source in communication with and supplying a pressurized fluid to at least one of the first plurality of fluid outlets and to at least one of the second plurality of fluid outlets; and a controller that controls movement of at least one of the first plurality of fluid outlets and the second plurality of fluid outlets in a direction orthogonal to the first major surface and the second major surface of the glass sheet to increase or decrease the gap.

In a second embodiment the apparatus of the of the first embodiment is such that the first plurality of fluid outlets are disposed in at least one first elongate bar comprising a plenum in fluid communication with the first plurality of fluid outlets, and wherein the second plurality of fluid outlets are disposed in at least one second elongate bar comprising a plenum in fluid communication with the second plurality of fluid outlets.

In a third embodiment, the first and second embodiments are such that the apparatus further comprises a plurality of first fluid nozzles including the first plurality of fluid outlets and a plurality of second fluid nozzles including the second plurality of fluid outlets. In a fourth embodiment, the first through third embodiments are such that the first plurality of fluid outlets are located in at least one first elongate bar comprising a plenum in fluid communication with the first plurality of fluid outlets, the apparatus further comprising a plurality of fluid nozzles including the second plurality of fluid outlets. In a fifth embodiment, the first through fourth embodiments are such that the first plurality of fluid outlets is movable from an open position at which the gap is at a maximum to a closed position at which the gap is at a minimum. In a sixth embodiment, first through fourth embodiments are such that the first plurality of fluid outlets and the second plurality of fluid outlets are movable from an open position at which the gap is at a maximum to a closed position at which the gap is at a minimum.

In a seventh embodiment, the second embodiment is such that the apparatus comprises a plurality of first elongate bars spaced apart on a first frame and a plurality of second elongate bars spaced apart on a second frame such that the plurality of first elongate bars and the plurality of second elongate bars are separated by the gap. In an eighth embodiment, the plurality of first elongate bars is pressurized with a first fluid and the plurality of second elongate bars is pressurized with a second fluid.

In a ninth embodiment, the first fluid and the second fluid comprise air or wherein the first fluid comprises air and the second fluid comprises a liquid. In a tenth embodiment, the apparatus comprises a plurality of first elongate bars spaced apart on a first frame and a plurality of fluid nozzles such that the plurality of first elongate bars and the plurality of fluid nozzles are separated by the gap.

In an eleventh embodiment, the first through tenth embodiments are such that when a pressurized fluid exits the first plurality of fluid outlets and the second plurality of fluid outlets to form a first fluid cushion between the first plurality of fluid outlets and the first major surface of the glass sheet and to form a second fluid cushion between the second plurality of fluid outlets and the second major surface of the glass sheet. In a twelfth embodiment, the first through tenth embodiments are such that a pressurized fluid exits the first plurality of fluid outlets and the second plurality of fluid outlets at a pressure sufficient to exert a stiffness-force between the first plurality of fluid outlets and the glass sheet and the second plurality of fluid outlets and the glass sheet to reduce an amount of bow of the glass sheet.

A thirteenth embodiment comprises a glass sheet processing system comprising any of the apparatus described with respect to the first through twelfth embodiments. For example, the system can comprise a first apparatus comprising opposed fluid outlets defining a gap, the opposed fluid outlets configured to direct pressurized fluid on a first major surface and a second major surface of a glass sheet to reduce bow in the glass sheet; and a second apparatus located downstream from the first apparatus comprising a plurality of liquid dispensing nozzles that can remove glass particles adhered at least one of the first major surface and the second major surface of the glass sheet after exiting the first apparatus. In a fourteenth embodiment, the thirteenth embodiment is such that the opposed fluid outlets comprise a first plurality of fluid outlets adjustably spaced apart from a second plurality of fluid outlets and defining a gap sized to pass a glass sheet comprising a first major surface and a second major surface defining a thickness, the first plurality of fluid outlets directed at the first major surface and the second plurality of fluid outlets directed at the second major surface when the glass sheet is disposed in the gap. In a fifteenth embodiment of a system, the first apparatus further comprises a pressurized fluid source in communication with and supplying a pressurized fluid to at least one of the first plurality of fluid outlets and to at least one of the second plurality of fluid outlets; and a controller that controls movement of at least one of the first plurality of fluid outlets and the second plurality of fluid outlets in a direction orthogonal to the first major surface and the second major surface of the glass sheet to increase or decrease the gap. In a sixteenth embodiment, the system further includes a third apparatus downstream from the second apparatus and positioned to receive the glass sheet from the second apparatus, the third apparatus comprising a gas knife to remove liquid from the glass sheet.

A seventeenth embodiment relates to a method of processing a glass sheet comprising placing a glass sheet between a first plurality of fluid outlets adjustably spaced apart from a second plurality of fluid outlets by a gap so that the first plurality of fluid outlets is directed at a first major surface of the glass sheet and the second plurality of fluid outlets is directed at a second major surface of the glass sheet; and directing pressurized fluid at the first major surface exiting the first plurality of fluid outlets and at the second major surface exiting the second plurality of fluid outlets to cool the glass sheet.

In an eighteenth embodiment, the seventeenth embodiment is such that the pressurized fluid exiting the first plurality of fluid outlets forms a first fluid cushion between the first plurality of fluid outlets and the first major surface of the glass sheet and the pressurized fluid exiting the second plurality of fluid outlets forms a second fluid cushion between the second plurality of fluid outlets and the second major surface of the glass sheet. In a nineteenth embodiment, the eighteenth embodiment is such that the first major surface and the second major surface of the glass sheet have an amount of bow prior to placing the glass sheet in the gap, and wherein the first fluid cushion and second fluid cushion reduce the amount of bow.

In a twentieth embodiment, the method is such that the pressurized fluid exits the first plurality of fluid outlets and the second plurality of fluid outlets at a pressure to exert a sufficient stiffness-force between the first plurality of fluid outlets and the first major surface and the second plurality of fluid outlets and the second major surface to reduce the amount of bow of the glass sheet.

In a twenty-first embodiment, the method is such that the first fluid cushion comprises an air cushion and the second fluid cushion comprises an air cushion. In a twenty second embodiment, the method is such that the first plurality of fluid outlets are disposed in a first elongate bar comprising a plenum in fluid communication with the first plurality of fluid outlets and the second plurality of fluid outlets are disposed in a second elongate bar comprising a plenum in fluid communication with the first plurality of fluid outlets. In a twenty-third embodiment, the method is such that a plurality of first fluid nozzles comprises the first plurality of fluid outlets and a plurality of second fluid nozzles comprises the second plurality of fluid outlets.

In a twenty-fourth embodiment, the method is such that the first plurality of fluid outlets are disposed in a first elongate bar comprising a plenum in fluid communication with the first plurality of fluid outlets and a plurality of second fluid nozzles comprise the second plurality of fluid outlets. In a twenty-firth embodiment, the method further comprises moving the first plurality of fluid outlets from an open position at which the gap is at a maximum to a closed position at which the gap is at a minimum.

### BRIEF DESCRIPTION OF THE DRAWINGS

These and other features, aspects, and advantages of the present disclosure can be further understood when read with reference to the accompanying drawings:

FIG. 1 is a schematic view of a glass processing apparatus including a fusion down-draw apparatus to draw a glass ribbon;

FIG. 2 is a schematic perspective view of a washing station of the glass processing apparatus;

FIG. 3 is a front perspective view of a bowed glass sheet;

FIG. 4A is a side view of a bowed glass sheet;

FIG. 4B is a side view of a bowed glass sheet;

FIG. 5 is a schematic perspective view of a glass processing apparatus in accordance with an embodiment;

FIG. 6 is a section view taken along line 6-6 of FIG. 1 showing the front of one side of the glass processing apparatus;

FIG. 7 is a back view of the one side of the glass processing apparatus shown in FIG. 6;

FIG. 8 is a perspective view of an elongate bar for directing fluid at a glass sheet;

FIG. 9 is a cross-sectional view taken along line 9-9 of FIG. 8;

FIG. 10 is a rear perspective view of the elongate bar shown in FIG. 8;

FIG. 11 is a section view taken along line 11-11 of FIG. 1 showing the front of the side of the glass processing apparatus opposite the side shown in FIG. 6;

FIG. 12 is a front view of an alternate embodiment of an elongate bar having a plurality of fluid outlets;

FIG. 13 is a front view of an embodiment an elongate bar for directing fluid at a glass sheet;

FIG. 14 is a perspective view showing an embodiment of a nozzle for directing fluid at a glass sheet;

FIG. 15 is a flow chart illustrating exemplary steps of processing a glass sheet in accordance with embodiments of the disclosure; and

FIG. 16 is a graph representing a glass sheet having approximately ˜12 mm bow prior to flattening and showing the amount of bow after being processed in an apparatus according to an embodiment of the disclosure.

### DETAILED DESCRIPTION

Apparatus and methods will now be described more fully hereinafter with reference to the accompanying drawings in which exemplary embodiments of the disclosure are shown. Whenever possible, the same reference numerals are used throughout the drawings to refer to the same or like parts. However, this disclosure may be embodied in many different forms and should not be construed as limited to the embodiments set forth herein.

It is to be understood that specific embodiments disclosed herein are intended to be exemplary and therefore non-limiting. As such, the present disclosure relates to methods and apparatus for processing at least one of a glass ribbon and a glass sheet. In some embodiments, the glass ribbon to be processed can be formed from a glass manufacturing apparatus, can be provided as it is being formed from a glass manufacturing apparatus, can be provided from a spool of previously-formed glass ribbon that can be uncoiled from the spool, or can be provided as a freestanding glass ribbon. In some embodiments, the glass sheet to be processed can be formed by a glass manufacturing apparatus, can be provided as a glass sheet separated from a glass ribbon, can be provided as a glass sheet separated from another glass sheet, can be provided as a glass sheet uncoiled from a spool of glass sheets, can be provided as a glass sheet obtained from a stack of glass sheets, or can be provided as a freestanding glass sheet.

Methods and apparatus for processing at least one of a glass ribbon and a glass sheet will now be described by way of exemplary embodiments including an embodiment for processing a glass ribbon formed from a glass manufacturing apparatus and an embodiment for processing a glass sheet separated from the glass ribbon. Other embodiments of processing at least one of a glass ribbon and a glass sheet are also described with the understanding that, with respect to at least some embodiments, similar or identical techniques may also be applied to process any one or more of the exemplary glass ribbons and glass sheets discussed above.

Embodiments of the present disclosure provides for processing at least one of a glass ribbon 103 and a glass sheet 104 to achieve desirable attributes. In some embodiments, the glass sheet 104 can be separated from the glass ribbon 103. In addition, the present disclosure provides exemplary glass processing apparatus, including the glass processing system 100 that may be used to process the glass ribbon 103 and the glass sheet 104 in accordance with embodiments of the present disclosure. As shown, the glass processing system 100 can include multiple exemplary processing stations that may be used individually or in combination with one another. As shown, the processing stations may be arranged in series with one another to process at least one of the glass ribbon 103 and the glass sheet 104 to provide desirable attributes. Moreover, it may be desirable to further process the glass ribbon 103 or the glass sheet 104 (e.g., by a customer further processing the glass sheet 104 for a display application). In some embodiments, systems, methods and apparatus provided herein can to prevent debris from coming into contact with and contaminating the glass ribbon 103 and the glass sheet 104, thus preserving the pristine characteristics of the glass ribbon 103 and the glass sheet 104 that may be desirable for various display applications.

Separation debris can include debris associated with the glass separator 149 and produced before, during, or after a separation process with the glass separator 149 under any type of operating conditions of the glass processing system 100. In some embodiments, separation debris can include glass shards and glass chips that are created when the glass ribbon 103 is scored as well as glass shards and glass chips that can break off from the glass ribbon 103 when the glass ribbon 103 is separated with the glass separator 149. Separation debris can also include particles and other contaminants emanating from the glass separator 149 and its related components, such as mechanical dust, lubricants, particulates, fibers, and any other type of debris. In some embodiments, separation debris can also include glass shards and glass chips that break off from the glass ribbon 103 when the glass ribbon 103 unexpectedly breaks, cracks, or shatters as a result of, for example, a processing malfunction. Environmental debris can include debris from the environment surrounding the glass ribbon 103 such as glass, glass particles, glass shards, glass chips, particulates, fibers, dust, human contaminants, and any other type of debris. In some embodiments, environmental debris can include dust and other particles that are liberated from the floor or other nearby structures within the environment where the glass processing system 100 is situated. Such environmental debris can become airborne when subjected to an airflow, such as a draft, a breeze, an air stream from the glass processing system 100, or when stirred up by a person (e.g., technician, operator), machine or other cause.

While exemplary orders of the processing stations are illustrated, in some embodiments, the processing stations may be arranged in a different order. In some embodiments, the glass processing system 100 may include more processing stations than the exemplary illustrated processing stations. In some embodiments, the glass processing system 100 may include less processing stations than the exemplary illustrated processing stations. Moreover, in some embodiments, a single processing station may be provided that can be used to process at least one of the glass ribbon 103 and the glass sheet 104, either alone, or in combination with any one or more other processing stations.

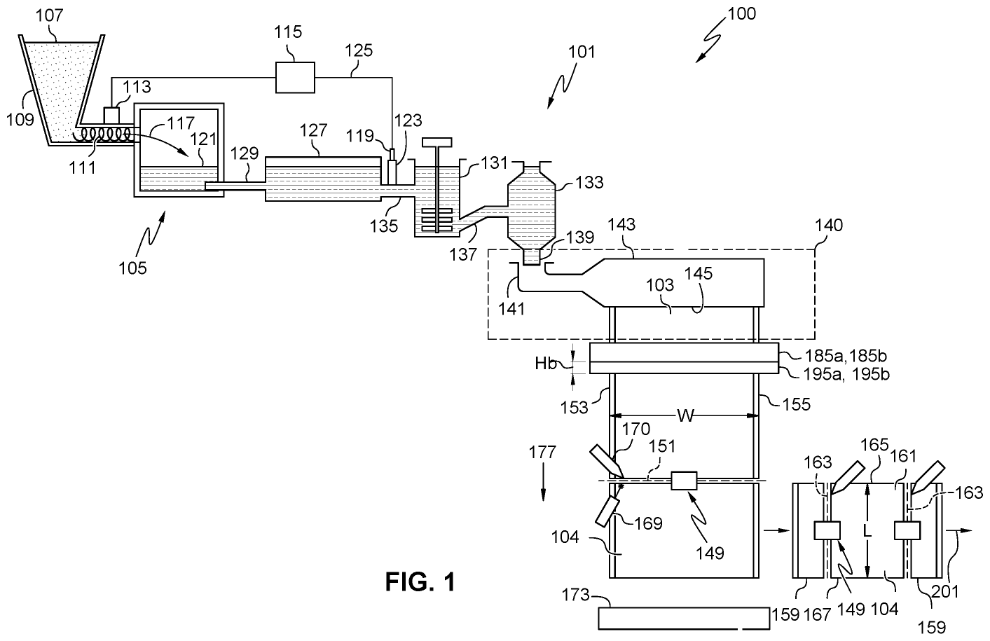

In some embodiments, the glass processing system 100 provides the glass ribbon 103 with a glass manufacturing apparatus 101 such as a slot draw apparatus, float bath apparatus, down-draw apparatus, up-draw apparatus, press-rolling apparatus, or other glass ribbon manufacturing apparatus. FIG. 1 schematically illustrates the glass manufacturing apparatus 101 including a fusion down-draw apparatus 101 for fusion drawing the glass ribbon 103 for subsequent processing into glass sheets 104.

The fusion down-draw apparatus 101 can include a melting vessel 105 oriented to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by arrow 117. A glass melt probe 119 can be used to measure a level of molten material 121 within a standpipe 123 and communicate the measured information to the controller 115 by way of a communication line 125.

The fusion down-draw apparatus 101 can also include a fining vessel 127 located downstream from the melting vessel 105 and coupled to the melting vessel 105 by way of a first connecting conduit 129. In some embodiments, molten material 121 may be gravity fed from the melting vessel 105 to the fining vessel 127 by way of the first connecting conduit 129. For example, gravity may act to drive the molten material 121 to pass through an interior pathway of the first connecting conduit 129 from the melting vessel 105 to the fining vessel 127. Within the fining vessel 127, bubbles may be removed from the molten material 121 by various techniques.

The fusion down-draw apparatus 101 can further include a mixing chamber 131 that may be located downstream from the fining vessel 127. The mixing chamber 131 can be used to provide a homogenous composition of molten material 121, thereby reducing or eliminating cords of inhomogeneity that may otherwise exist within the molten material 121 exiting the fining vessel 127. As shown, the fining vessel 127 may be coupled to the mixing chamber 131 by way of a second connecting conduit 135. In some embodiments, molten material 121 may be gravity fed from the fining vessel 127 to the mixing chamber 131 by way of the second connecting conduit 135. For example, gravity may act to drive the molten material 121 to pass through an interior pathway of the second connecting conduit 135 from the fining vessel 127 to the mixing chamber 131.

The fusion down-draw apparatus 101 can further include a delivery vessel 133 that may be located downstream from the mixing chamber 131. The delivery vessel 133 may condition the molten material 121 to be fed into a glass former 140. For example, the delivery vessel 133 can act as an accumulator and/or flow controller to adjust and provide a consistent flow of molten material 121 to the glass former 140. As shown, the mixing chamber 131 may be coupled to the delivery vessel 133 by way of a third connecting conduit 137. In some embodiments, molten material 121 may be gravity fed from the mixing chamber 131 to the delivery vessel 133 by way of the third connecting conduit 137. For example, gravity may act to drive the molten material 121 to pass through an interior pathway of the third connecting conduit 137 from the mixing chamber 131 to the delivery vessel 133.

As further illustrated, a delivery pipe 139 can be positioned to deliver molten material 121 to the glass former 140 of the fusion down-draw apparatus 101. As discussed more fully below, the glass former 140 may draw the molten material 121 into the glass ribbon 103 off of a root 145 of a forming vessel 143. In the illustrated embodiment, the forming vessel 143 can include an inlet 141 oriented to receive molten material 121 from the delivery pipe 139 of the delivery vessel 133.

In some embodiments, the width “W” of the glass ribbon 103 and a glass sheet 104 can be from about 20 mm to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 3000 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

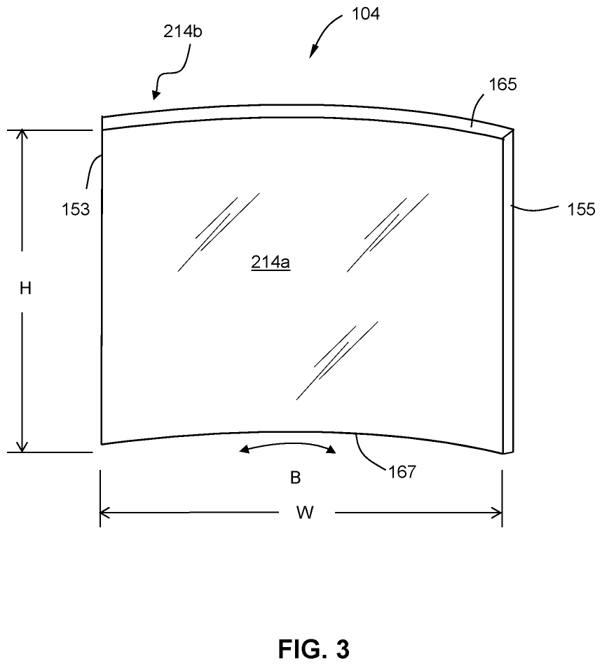

In some embodiments, the height “H” of the glass ribbon 103 and a glass sheet 104 (as shown in FIG. 3) can be from about 20 mm to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 2500 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

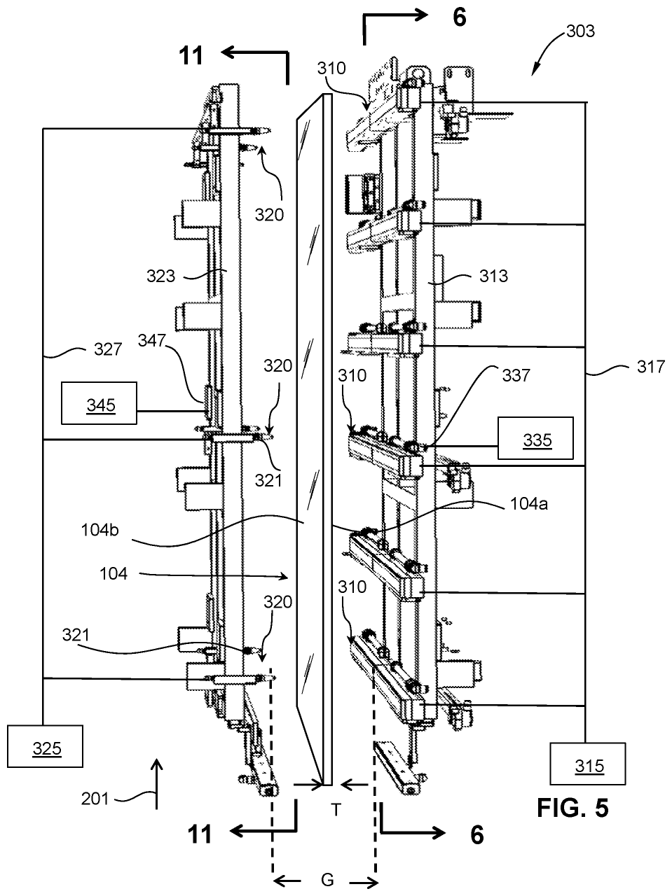

In some embodiments, the thickness “T” (as shown in FIG. 5) of a glass sheet 104 made from glass ribbon 103 can be in a range of from about 0.01 mm to about 5 mm, such as from about 0.05 mm to about 3 mm, such as from about 0.05 mm to about 2 mm, such as from about 0.05 mm to about 1.8 mm, such as from about 0.05 mm to about 1.3 mm, and all ranges and subranges therebetween.

The glass ribbon 103 can include a variety of compositions including but not limited to soda-lime glass, borosilicate glass, alumino-borosilicate glass, an alkali-containing glass, or an alkali-free glass. Once exiting the glass former 140, the glass ribbon 103 can then eventually be separated into one or more glass sheets 104 by a glass separator 149. As shown, the glass separator 149 can be positioned downstream from the glass former 140 and oriented to separate the glass sheet 104 from the glass ribbon 103. A variety of glass separators 149 may be provided in embodiments of the present disclosure. For example, a traveling anvil machine may be provided that can score and then break the glass ribbon 103 along the score line. In some embodiments, a laser-assisted separation device may be provided as described below and also in co-pending U.S. Patent Application Publication No. 20160136846, the entirety of which is incorporated herein by reference. Such laser-assisted separation devices can include, but are not limited to, laser scoring techniques that heat the glass ribbon 103 and then cool the glass ribbon 103 to create a vent in the glass ribbon 103 to separate the glass ribbon 103. Such laser-assisted separation devices may also include laser cutting techniques that heat the glass ribbon 103 to produce a stressed region in the glass ribbon 103 and then apply a defect to the stressed region of the glass ribbon 103 to initiate a crack to separate the glass ribbon 103. FIG. 1 illustrates a general schematic of an exemplary glass separator 149. As illustrated, an exemplary glass separator 149 may separate the glass sheet 104 from the glass ribbon 103 along the transverse separation path 151 that extends along the width “W” of the glass ribbon 103, transverse to the draw direction 177 of the glass former 140, between a first vertical edge 153 of the glass ribbon 103 and a second vertical edge 155 of the glass ribbon 103.

In some embodiments, the glass separator 149 can separate an outer portion 159 of the glass sheet 104 from a central portion 161 of the glass sheet 104 along a vertical separation path 163 that extends along a length “L” between a first transverse edge 165 of the glass sheet 104 and a second transverse edge 167 of the glass sheet 104. As illustrated, such a technique can be carried out in a vertical orientation, although horizontal orientations may be provided in some embodiments. In some embodiments, a vertical orientation may facilitate the carrying away of glass particles by gravity.

In some embodiments, a defect (not shown) may be created by mechanically engaging the glass ribbon 103 with, for example, a scribe 170 (e.g., score wheel, diamond tip, etc.) or other mechanical device. A tip of the scribe 170 can create a defect such as a surface imperfection (e.g., surface crack). In some embodiments, the defect may include a point defect or a score line. Although not shown, a support device such as an air bearing or mechanical contact support member may be provided to help counteract the force applied by the scribe 170 to facilitate creation of the defect.

In some embodiments, the defect may be created with a laser 169. In some embodiments, the laser 169 can include a pulse laser configured to create the defect such as a surface imperfection although sub-surface imperfections may also be provided. In some embodiments, the defect produced by the laser 169 can include a crack, a point defect, a score line, or other defect wherein such defect 703 may optionally be created by an ablation process.

Any of the methods discussed herein may be applied to separate glass (e.g., glass ribbon 103, glass sheet 104) including but not limited to the exemplary types of glass ribbons 103 and glass sheets 104 disclosed herein. As such, embodiments discussed with respect to the glass ribbon 103 may also apply to the glass sheet 104. For example, as illustrated with respect to FIG. 1, the transverse separation path 151 can extend along the width “W” of the glass ribbon 103 between the first vertical edge 153 of the glass ribbon 103 and the second vertical edge 155 of the glass ribbon 103. In such embodiments, creating the defect can separate a glass sheet 104 from the glass ribbon 103 as shown in FIG. 1. In some embodiments also illustrated in FIG. 1, the vertical separation path 163 can extend along the length “L” of the glass sheet 104 between the first transverse edge 165 of the glass sheet 104 and the second transverse edge 167 of the glass sheet 104. In such embodiments, creating the defect can separate the outer portion 159 of the glass sheet 104 from the central portion 161 of the glass sheet 104.

As shown in FIG. 1, in some embodiments, the method of separating the glass sheet 104 from the glass ribbon 103 can be carried out without the need to bend the glass ribbon 103 or the glass sheet 104, including the outer portions 159 of the glass sheet 104. Indeed, as shown in FIG. 1, the glass separator 149 can separate the glass sheet 104 from the glass ribbon 103 while the glass sheet 104 and the glass ribbon 103 remain vertically oriented. In such an embodiment, debris generated during separation can be drawn vertically downward by gravity, thereby avoiding a horizontal or angled surface on which the debris may otherwise land if the glass ribbon 103 or glass sheet 104 were to include a bent (e.g., non-vertical) orientation. Likewise, due to the vertical orientation of the glass ribbon 103 and the glass sheet 104, environmental debris may be less likely to come into contact with the glass ribbon 103 and the glass sheet 104 as such environmental debris can also be drawn downward by gravity.

In some embodiments, a first elongated gas port 185a and a second elongated gas port 185b may be positioned adjacent the glass former 140, such as near where the glass ribbon 103 exits the glass former 140. The first elongated gas port 185a and the second elongated gas port 185b can be oriented to respectively distribute a first outer curtain of gas and a second outer curtain of gas, for example, along the entire width “W” of the glass ribbon 103 or even greater than the entire width “W” of the glass ribbon 103. In some embodiments, the first elongated gas port 185a and the second elongated gas port 185b can be oriented to respectively distribute a first outer curtain of gas and a second outer curtain of gas along less than the entire width “W” of the glass ribbon 103. Additionally, in some embodiments, the first outer curtain of gas and the second outer curtain of gas can surround the glass ribbon 103 entirely, in some embodiments, and can isolate the glass ribbon 103 from contamination with environmental debris. The first elongated gas port 185a and the second elongated gas port 185b can include a single elongated nozzle, port, jet, etc. from which gas can be distributed or a plurality of nozzles, ports, jets, etc. from which gas can be distributed to form a continuous, uniform curtain of gas that may inhibit or even prevent penetration by environmental debris. In some embodiments, each of the first elongated gas port 185a and the second elongated gas port 185b can include any one or more of a continuous elongated slot and a plurality of elongated slots oriented to respectively distribute the first outer curtain of gas and the second outer curtain of gas.

The glass processing system 100 can include a vacuum port 173 (e.g., an elongated vacuum port) positioned downstream (e.g., along the draw direction 177, shown in FIG. 1) from the glass separator 149 and oriented to receive debris entrained in the first outer curtain of gas and the second outer curtain of gas. In some embodiments, the vacuum port 173 can be oriented to receive debris entrained in the first inner curtain of gas and the second inner curtain of gas. The vacuum source can include a blower, a vacuum chamber, a pump, a fan, or other suitable mechanism to create an under pressure (e.g., negative pressure, suction) at the vacuum port 173.

In some embodiments, a baffle (e.g., first baffle 195a, second baffle 195b) may be provided to avoid interference between the first outer curtain of gas and the second outer curtain of gas with a cooling stream being drawn into the lower opening of the glass former 140. In some embodiments, any of the baffles of the disclosure can extend downstream in a direction away from the glass former 140. In some embodiments, any of the baffles of the disclosure can be positioned at least partially outside the glass former 140, such as entirely outside of the glass former 140. In further examples, at least a portion of any of the baffles of the disclosure can extend partially within the glass former 140. The first baffle 195a and the second baffle 195b can extend along the entire width “W” of the glass ribbon 103 and, as shown, can extend along greater than the entire width “W” of the glass ribbon 103. In some embodiments, the first baffle 195a and the second baffle 195b can extend along less than the entire width “W” of the glass ribbon 103.

In some embodiments, the first baffle 195a and/or the second baffle 195b can be adjustable such that the height “Hb” of each of the first baffle 195a and the second baffle 195b can be selectively adjusted,

In some embodiments, the first elongated gas port 185a and the second elongated gas port 185b can include a single elongated nozzle, port, jet, etc. that can be split by the respective first baffle 195a and the second baffle 195b and from which gas can be distributed to pass over both sides of each of the respective first baffle 195a and the second baffle 195b to form continuous, uniform curtains of gas that may inhibit or even prevent penetration by environmental debris. In some embodiments, the first elongated gas port 185a and the second elongated gas port 185b can include a plurality of nozzles, ports, jets, etc. that can be arranged on both sides of the first baffle 195a and the second baffle 195b and from which gas can be distributed to form continuous, uniform curtains of gas that may inhibit or even prevent penetration by environmental debris. In some embodiments, each of the first elongated gas port 185a and the second elongated gas port 185b can include any one or more of a continuous elongated slot and a plurality of elongated slots.

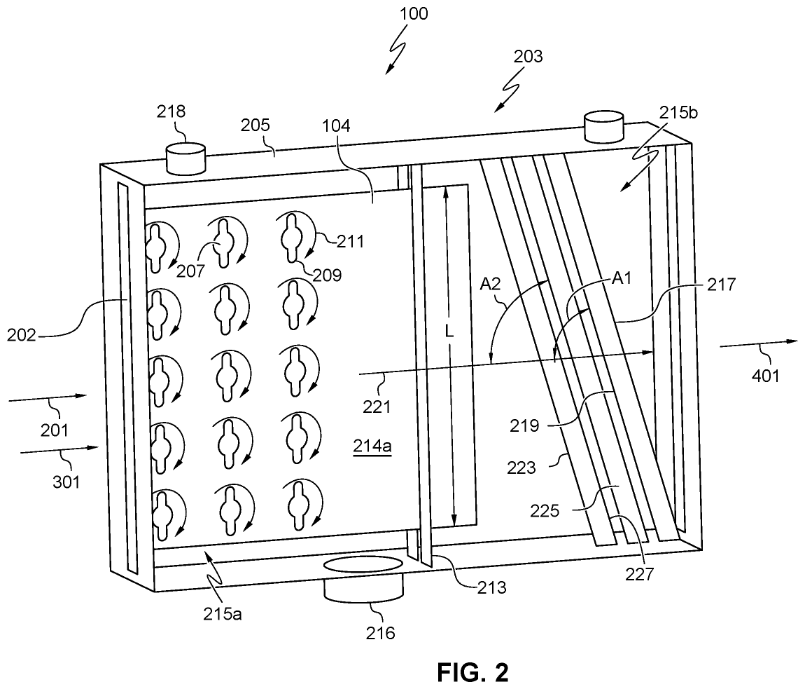

According to one or more embodiments, apparatus and methods are provided for processing a glass ribbon and/or a glass sheet. In specific embodiments, the apparatus and methods can be used to prepare a glass sheet for further processing through a washer 203 used to clean off glass chips and/or particles from the glass sheet, such as a high pressure water washing system having a narrow passageway between nozzles of the washing system. An exemplary embodiment of a washer 203 is shown in FIG. 2, including an entrance opening 202 that may be relatively narrow, for example having width of about less than about 100 mm, for example about 20 mm. In one or more embodiments, apparatus and methods are disclosed herein that pre-position the glass sheet and make the glass sheet sufficiently flat and aligned in the same plane as the washing system due to the relatively narrow entrance opening required for the cleaning and subsequent drying processes. The method and apparatus according to some embodiments will also rapidly cool the glass sheet, resulting in removal of the bow. According to one or more embodiments, the apparatus and methods will also flatten and align the glass substrate within the plane of the major surfaces of the glass sheet. In some embodiments, the methods and apparatus could be used to solve an issue in which a bowed thin glass sheet would require flattening without touching the one of the major surfaces, for example, to prepare the glass sheet for a precision measurement.

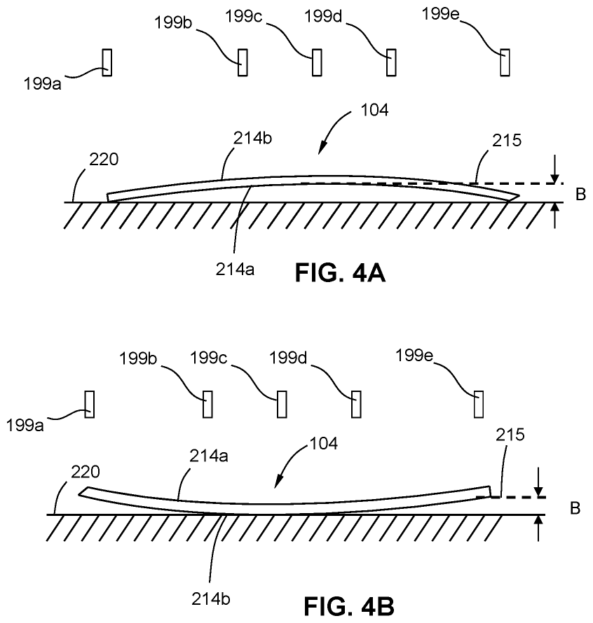

According to one or more embodiments bow “B” can be measured by placing a glass substrate on a flat table in a mechanically unconstrained state, and measuring the deviation from the table to the greatest distance extending from the table. FIG. 3 shows an exaggerated view a bowed glass sheet 104 that can be obtained from a ribbon forming processes including, float, slot draw, down-draw, fusion down-draw, and up-draw. The glass sheet 104 may be warped and/or bowed as a result of the thermal history and stresses placed on the ribbon 103 during the forming process. FIG. 3 shows the bow, labelled as “B.” According to some embodiments, the term “warp” refers to the difference between the maximum and minimum deviations of the median surface relative to the backside reference plane. Warp can be similar to wavy deformation present in potato chips. According to some embodiments, the term “bow” refers to the measure of how concave or convex the deformation of the median surface of the glass sheet at the center point, independent of any thickness variations. For example, as shown in FIG. 4A, a glass sheet 104 is shown wherein the second major surface 214b is a convex major surface, with the first major surface 214a facing towards table surface 220. The distance “B” between line 215 and table surface 220 provides the bow of the substrate. Alternatively, bow can be measured as shown in FIG. 4B, with the first major surface 214a facing upwardly and the second major surface 214b facing towards the table 220. The distance between “B” between line 215 and table surface 220 provides the bow of the substrate.

In this disclosure, bow was measured by placing an array of ultrasonic sensors 199a-e fixed in a plane above the glass sheet 104. The ultrasonic sensors emit one or multiple pulses of ultrasonic energy, which travel through the air at the speed of sound. A portion of this energy reflects off the target and travels back to the sensor. The sensor measures the total time required for the energy to reach the target and return to the sensor. The distance to the object is then calculated using the following formula: D=ct÷2, where D=distance from the sensor to the target, c=speed of sound in air and t=transit time for the ultrasonic pulse. In some embodiments, to improve accuracy, an ultrasonic sensor may average the results of several pulses before outputting a new value. The distance measured by each sensor spaced apart above the glass sheet can then be used to calculate bow of the glass sheet 104. For example, in FIG. 4A, sensors 199a and 199e will measure a distance that is greater than the distance measured by sensors 199b and 199d, which will measure a distance greater than the distance measured by sensor 199c. It will be understood that the number of sensors 199a-e shown in FIGS. 4A and 4B is exemplary, and more or fewer sensors may be utilized. The greatest distance measured by sensors 199a or 199e would then be compared with the distance measured by sensor 199c determine the amount of bow B. A similar determination could be made with respect to FIG. 4B. In one or more embodiments, sensors 199a and 199e would be positioned at edges of the glass sheet 104, and sensor 199c would be positioned at a midpoint of the glass sheet between the edges.

As noted above, a glass shape variation or bow of 25 mm in a major plane (z-plane) of a glass sheet over 1.5 meters in a direction transverse to the major plane (x-direction or y-direction) has been observed. As indicated by arrow 201 in FIG. 1 and FIG. 2, the glass sheet 104 exits glass processing system 100 to the next processing station in the system.

In some embodiments, the glass sheet 104 can be quickly moved between the separation station (e.g., the glass separator 149) and the washing station (e.g., the washer 203). As discussed above, moving the glass sheet 104 relatively quickly from the glass separator 149 to be received by the washer 203 can help prevent debris (e.g., glass shards, particles, etc.) from adhering to a pristine major surface of the glass sheet 104. Indeed, debris landing on a major surface of the glass sheet 104 during the separation steps can be quickly removed before the debris has time to form a significant bond with the major surface of the glass sheet 104. In some embodiments, relatively quick movement of the glass sheet 104 (represented by travel direction 221 in FIGS. 1 and 2) can involve a time lapse of from about 1 second to about 20 seconds, such as from about 1 second to about 15 seconds, from the time the glass sheet 104 leaves the separation station until the glass sheet 104 begins being received by the washer 203.

The washer 203 can include a housing 205 with a first liquid dispenser 207 (e.g., a plurality of first liquid dispensers 207) including a first liquid nozzle 209 (e.g., a plurality of first liquid nozzles 209) oriented to dispense liquid against first major surface 214a and second major surface 214b of the glass sheet 104 to remove glass particles adhered to first major surface 214a and/or second major surface 214b of the glass sheet 104. While not shown, an exemplary washer 203 can dispense liquid against both the first major surface 214a of the glass sheet 104 and the second major surface 214b of the glass sheet 104. Accordingly, the depiction of single-sided dispensing, unless otherwise noted, should not limit the scope of the claims appended herewith as such a depiction was conducted for purposes of visual clarity. As shown, the first liquid nozzles 209 can optionally rotate about a rotational axis as indicated by rotational arrows 211. In some embodiments (not shown), the first liquid nozzles 209 can be fixed and non-rotating. Suitable nozzles can include any one or more cone nozzles, flat nozzles, solid stream nozzles, hollow cone nozzles, fine spray nozzles, oval nozzles, square nozzles, etc. In some embodiments, the nozzles can include a flow rate from about 0.25 to about 2500 gallons per minute (gpm) that operate with pressures of from about 0 psi to about 4000 psi. Other nozzle types and designs, including nozzles not explicitly disclosed herein, may be provided in some embodiments.

In some embodiments, the housing 205 can be substantially enclosed, although a side wall of FIG. 2 has been removed to reveal features in the interior of the housing 205. In some embodiments, the housing 205 can include a partition 213 dividing an interior of the housing 205 into a first area 215a and a second area 215b. The second area 215b can be positioned downstream (e.g., along travel direction 221) from the first area 215a. In the illustrated embodiment, the first area 215a can include the first liquid dispenser 207. A drain 216 can be provided to remove the liquid with any debris entrained in the liquid from the process of washing within the first area 215a. A vent 218 can also be provided to prevent pressure build up and to allow vapor and/or gas to escape from the first area 215a of the housing 205. As shown, exemplary embodiments can process a glass sheet 104 in a vertical orientation. Suitable mechanisms used for such vertical orientation and movement thereof are described in WO2016064950 A1.

The washer 203 can further include a gas knife 217 positioned downstream (e.g., along travel direction 221) from the first liquid dispenser 207, such as within the second area 215b of the housing 205, as shown. The gas knife 217 can include a gas nozzle 219 (e.g., an elongated nozzle) oriented to extend along the entire length “L” of the glass sheet 104 and oriented to dispense gas against the first major surface 214a and the second major surface 214b of the glass sheet 104 to remove liquid from the first major surface 214a and the second major surface 214b of the glass sheet 104. The gas knife 217 may be oriented at a first angle “A1” relative to the travel direction 221 of the glass sheet 104 through the washer 203. In some embodiments, the first angle “A1” can be about 90° (e.g., vertical), about 45°, from about 45° to about 90°, for example, from about 60° to about 85°, for example, from about 70° to about 80°, and all ranges and subranges therebetween. In some embodiments, the first angle “A1” can be about 135°, from about 90° to about 135°, for example, from about 95° to about 120°, for example, from about 100° to about 110°, and all ranges and subranges therebetween. The gas knife 217 can be designed to dispense gas against the first major surface 214a and the second major surface 214b of the glass sheet 104 to remove liquid from the first major surface 214a and the second major surface 214b of the glass sheet 104. Suitable gases include, but are not limited to, air, nitrogen, low humidity gases, and the like.

As further illustrated, the second area 215b can optionally include a second liquid dispenser 223 including a second liquid nozzle 227 oriented to rinse the first major surface 214a and the second major surface 214b of the glass sheet 104 at a location upstream (e.g., along travel direction 221) from the gas knife 217. In some embodiments, the second liquid dispenser 223 can include a lower pressure liquid stream when compared to the pressure of the liquid stream generated by the first liquid dispenser 207 in the first area 215a. Indeed, the lower pressure liquid stream of the second liquid dispenser 223 can flood the first major surface 214a and the second major surface 214b of the glass sheet 104 to remove any detergents, chemicals, debris, or other impurities remaining on the glass sheet 104. As shown, in some embodiments, a deflector 225 can be positioned downstream (e.g., along travel direction 221) from the second liquid dispenser 223 and upstream from the gas knife 217. The deflector 225 can be oriented to direct an amount of liquid from the second liquid dispenser 223 away from the gas knife 217. As shown, the deflector 225, such as a wiper blade, may be oriented at a second angle “A2” relative to the travel direction 221 of the glass sheet 104 through the washer 203. As shown, the first angle “A1” and the second angle “A2” can be substantially equal to one another; however, such a depiction, unless otherwise noted, should not limit the scope of the claims appended herewith as different angles (oblique, acute, etc. to the direction of travel) may be provided in some embodiments. Moreover, as shown, the second liquid dispenser 223 may likewise optionally include a second liquid nozzle 227 (e.g., an elongated liquid nozzle) oriented at a similar or identical angle of the deflector 225 and the gas knife 217 relative to the travel direction 221 of the glass sheet 104 through the washer 203. The deflector 225 can direct liquid from the second liquid dispenser 223 downward and away from the gas knife 217, thereby reducing the amount of liquid that the gas knife 217 is required to remove from the glass sheet 104.

Although features of FIG. 2 are illustrated acting on a single one of the first major surface 214a and the second major surface 214b of the glass sheet 104, it will be appreciated that similar or identical features may be provided on both sides of the glass sheet 104 to thoroughly wash both the first major surface 214a of the glass sheet 104 and the second major surface 214b of the glass sheet 104. Accordingly, the left side perspective view of the washer 203 can be a mirror image of the right side perspective view of the washer 203 illustrated in FIG. 2 and the above discussion and the depiction in FIG. 2 were made for purposes of visual clarity.

Although not shown, the glass sheet 104 may then be dried, for example, with a gas knife or other drying procedure. As indicated by arrow 401 in FIG. 2, the clean and dry glass sheet 104 exiting the washer 203 may then be coated by a coating chamber (not shown), or inspected in an inspection apparatus (not shown) or measured in a measurement apparatus (not shown). An inspection apparatus may inspect one or more attributes of the glass sheet 104 to ensure quality and to determine whether the glass sheet 104 meets one or more requirements that may be set by a customer. The inspection apparatus can be designed to sense one or more of bubbles, inclusions, surface particles, cord, thickness, squareness, dimensions, edge quality, scratches, cracks, surface imperfections, surface shape, surface characteristics or other attributes of the glass sheet 104.

If the glass sheet 104 meets the inspection requirements, the clean glass sheet 104 may be packaged together with other glass sheets 104. In some embodiments, the glass sheets 104 may be placed in a stack with high quality interleaf paper or other material (e.g., polymeric material) disposed between adjacent glass sheets 104. The high quality interleaf paper or other material can be selected to avoid any contamination of the glass sheet 104 with chemicals or fibers.

One or more embodiments of the disclosure provide glass processing apparatus and methods to receive the glass sheet downstream from the glass manufacturing apparatus 101 shown in FIG. 1 as indicated by arrow 201 to the next downstream processing station. The next downstream processing station can include one or more apparatus for further processing of the glass sheet, which may include, a cleaning station, a drying station, a coating station, a measurement station, an inspection station etc. In some embodiments, the next processing station may include a washer 203 as shown by arrow 201 in FIG. 2 including an entrance opening 202 that may be relatively narrow, for example having width of about less than about 100 mm, for example 20 mm. A narrow entrance opening 202 that exceeds the amount of bow “B” of a glass sheet, the glass sheet may contact the entrance opening, causing scratches or other damage to the glass sheet 104. Other downstream processing stations such as a drying station, a coating station, an inspection station or a measurement station may also have narrow openings through which the glass sheet passes through, and therefore, reducing or eliminating the amount of bow in the glass sheet will reduce scratching and possible breaking of glass sheets. Furthermore the washer 203 may include opposed liquid nozzles that are spaced apart at a distance such that the nozzles may contact a bowed glass sheet 104, such as the glass sheet 104 shown in FIG. 3. Therefore, it is desirable in one or more embodiments to process the glass sheet upstream from the washing station and other processing stations to reduce bow in the glass sheet.

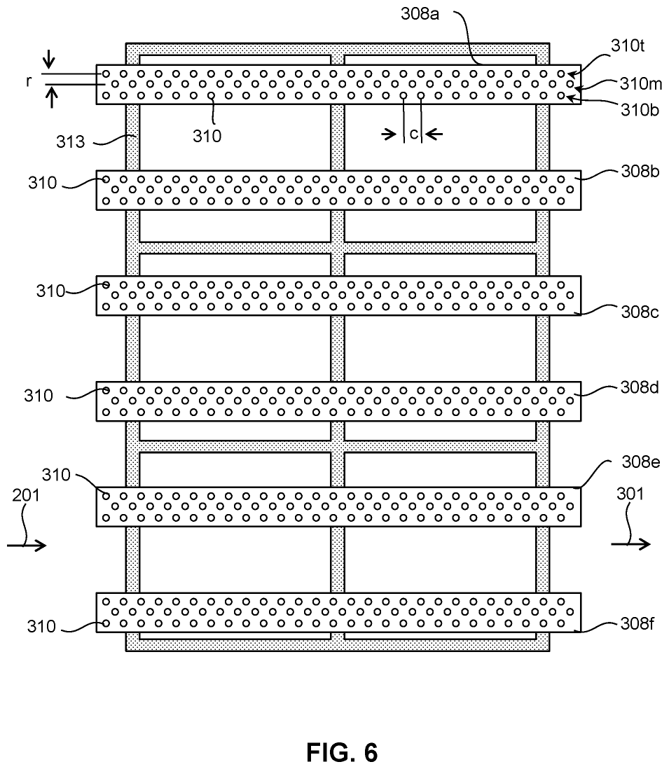

According to one or more embodiments, a glass processing apparatus 303 and methods are provided that can “flatten” a bowed glass substrate to reduce the amount of bow in a glass substrate. Such an apparatus can be placed downstream from the glass manufacturing apparatus 101 as indicated by arrow 201 in FIGS. 1, 5 and 6. In accordance with one or more embodiments, after being processed in the apparatus 303, the glass sheet 104 may be directed to the next processing station downstream from the apparatus 303 as indicated by arrow 301 shown in FIG. 6. The next downstream apparatus can be the washer 203 shown in FIG. 2, or other processing apparatus not shown such as a drying apparatus, a coater, a measurement apparatus or an inspection apparatus.

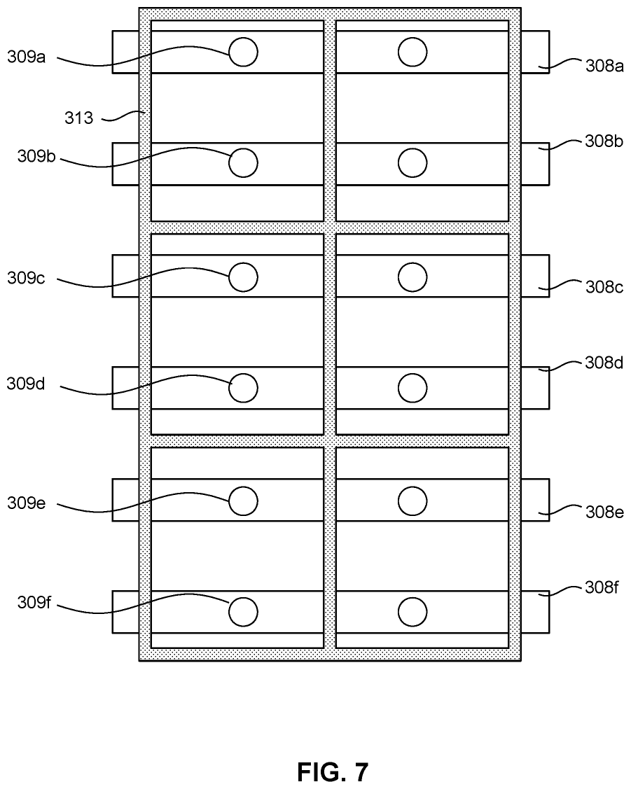

Referring now to FIGS. 5-13, embodiments of a glass sheet processing apparatus 303 are shown. As shown in FIG. 5, an exemplary glass sheet processing apparatus 303 comprises a first plurality of fluid outlets 310 adjustably spaced apart from a second plurality of fluid outlets 320 and defining a gap “G” sized to pass a glass sheet 104 comprising a first major surface 104a and a second major surface 104b defining a thickness “T”, the first plurality of fluid outlets 310 directed at the first major surface 104a and the second plurality of fluid outlets 320 directed at the second major surface 104b when the glass sheet 104 is disposed in the gap “G”. The glass sheet processing apparatus 303 further comprises a pressurized fluid source 315 in communication with and supplying a pressurized fluid to at least one of the first plurality of fluid outlets 310 and to at least one of the second plurality of fluid outlets 320. As shown in FIG. 5, there may be a first pressurized fluid source 315 in communication with a first supply line 317 to supply the pressurized fluid to the first plurality of fluid outlets 310.

In some embodiments, a single pressurized fluid source may supply the first plurality of fluid outlets 310 and the second plurality of fluid outlets 320. However, in the embodiment shown in FIG. 5, a second pressurized fluid source 325 supplies a pressurized fluid to the second plurality of fluid outlets 320 by a second supply line 327. The first supply line 317 and the second supply line 327 can comprise pipe, conduit, tubing or hose that can supply a pressurized fluid such as a pressurized liquid (e.g., water) or a pressurized gas (e.g., air).

The glass sheet processing apparatus 303 shown in FIG. 5 may further comprise a first controller 335 that controls movement of at least one of the first pluralities of fluid outlets 310 and the second plurality of fluid outlets 320 in a direction orthogonal to the first major surface and the second major surface of the glass sheet to increase or decrease the gap “G”. The controller 335 may be a manual motion controller such as a worm gear that can be turned to increase or decrease the gap “G.” The glass sheet processing apparatus may include a second controller 345 that separately controls movement of the second plurality of fluid outlets 320 in a direction orthogonal to the first major surface and the second major surface of the glass sheet, while the first controller 335 controls movement of the first plurality of fluid outlets in a direction orthogonal to the first major surface and the second major surface of the glass sheet 310 to increase or decrease the gap “G”. The second controller 345 can be a manual motion controller such as a worm gear that can be turned to increase or decrease the gap “G.” In some embodiments, the first controller 335 is in communication with a first actuator 337 that controls movement of the first plurality of fluid outlets 310 in a direction orthogonal to the first major surface and the second major surface of the glass sheet to increase or decrease the gap “G”. The first controller 335 may also be in communication with a second actuator 347 that controls movement of the second plurality of fluid outlets 320 in a direction orthogonal to the first major surface and the second major surface of the glass sheet to increase or decrease the gap “G”. In some embodiments, the second controller 345 is in communication with the second actuator 347 which controls movement of the second plurality of fluid outlets 320 in a direction orthogonal to the first major surface and the second major surface of the glass sheet to increase or decrease the gap “G”. The first actuator 337 and the second actuator 347 may be part of a motor, pneumatic or hydraulic motion control system that can advance and retract the first fluid outlets 310 and the second fluid outlets 320. The apparatus may also include position sensors (not shown) positioned adjacent the first plurality of fluid outlets 310 to detect the distance from the first plurality of fluid outlets 310 to the first major surface 104a of the glass sheet. Similarly, position sensors may be positioned adjacent the second plurality of fluid outlets 320 to detect the distance from the second plurality of fluid outlets 320 to the second major surface 104b of the glass sheet. The position sensor can be in electrical communication with one or both of the controllers 335, 345 to dynamically control the distance of the respective fluid outlets from the major surfaces of the glass sheet. The position sensors can be any suitable position sensor such as a laser diode or an ultrasonic sensor.

In embodiments in which ultrasonic sensors are utilized, the ultrasonic sensors emit one or multiple pulses of ultrasonic energy, which travel through the air at the speed of sound. A portion of this energy reflects off the target and travels back to the sensor. The sensor measures the total time required for the energy to reach the target and return to the sensor. The distance to the object is then calculated using the following formula: D=ct÷2, where D=distance from the sensor to the target, c=speed of sound in air and t=transit time for the ultrasonic pulse. In some embodiments, to improve accuracy, an ultrasonic sensor may average the results of several pulses before outputting a new value.

The first controller 335 and/or second controller 345 according to some embodiments includes a first central processing unit (CPU), a memory, and support circuits (not shown). The first controller 335 and/or the second controller 345 may control movement directly, or via computers (or controllers) associated with particular monitoring system and/or support system components. The first controller 335 and/or the second controller 345 may be one of any form of general-purpose computer processor that can be used in an industrial setting for controlling linear motion of machine components. The memory, or computer readable medium, of the first controller 335 and/or the second controller 345 may be one or more of readily available memory such as random access memory (RAM), read only memory (ROM), floppy disk, hard disk, optical storage media (e.g., compact disc or digital video disc), flash drive, or any other form of digital storage, local or remote. The support circuits of the first controller 335 and/or the second controller 345 are coupled to the first CPU for supporting the processor in a conventional manner. These circuits include cache, power supplies, clock circuits, input/output circuitry and subsystems, and the like. One or more processes may be stored in the memory as software routine that may be executed or invoked to control movement of the first fluid outlets 310 and/or the second plurality of fluid outlets 320 to increase or decrease the gap G during processing of a glass sheet. The software routine may also be stored and/or executed by a second CPU (not shown) that is remotely located from the hardware being controlled by the first CPU. The first controller 335 and/or the second controller 345 may be linked via a hard wired connection or wirelessly, for example, using a Bluetooth or other suitable wireless connection.

In some embodiments, an optional edge gripping device may be utilized to grip the glass sheet near first vertical edge 153, second vertical edge 155, first transverse edge 165 or second transverse edge 167. A suitable gripping device is shown and described with respect to FIG. 14 of United States Patent Application Publication No. 20180044218. The gripping device can also comprise a pair of rollers that engage the glass sheet at the edge to advance the glass sheet though the glass sheet processing apparatus 303. The gripping device of some embodiments may comprise pads that are disposed on opposite sides of the major surfaces of the glass sheet, which are controlled by a motion system that moves the pads orthogonally with respect to the major surfaces of the glass sheet. The motion may be actuated by a pneumatic cylinder that effectively pinches the glass sheet at the edges. The gripping device may also be movable parallel to the plane of the glass sheet by a pneumatic slide to place the glass sheet in tension. More specifically, gripping three gripping devices may be spaced along one vertical edge (e.g. first vertical edge 153) and three gripping devices may be spaced along the other vertical edge (e.g., the second vertical edge 153) of the glass sheet. Tension may be applied by moving the gripping devices on the first vertical edge 153 and the second vertical edge in opposite directions.

Referring now to FIGS. 6-10, which show the first plurality of fluid outlets 310 as disposed in a first elongate bar 308a comprising a plenum 306a in communication with the first plurality of fluid outlets 310. The elongate bar 308a can be a hollow elongate bar comprising the plenum 306a, with the first plurality of fluid outlets 310 in communication with the plenum 306a and at least a first inlet 309a, which may be in fluid communication with the first supply line 317 and the first pressurized fluid source 315.

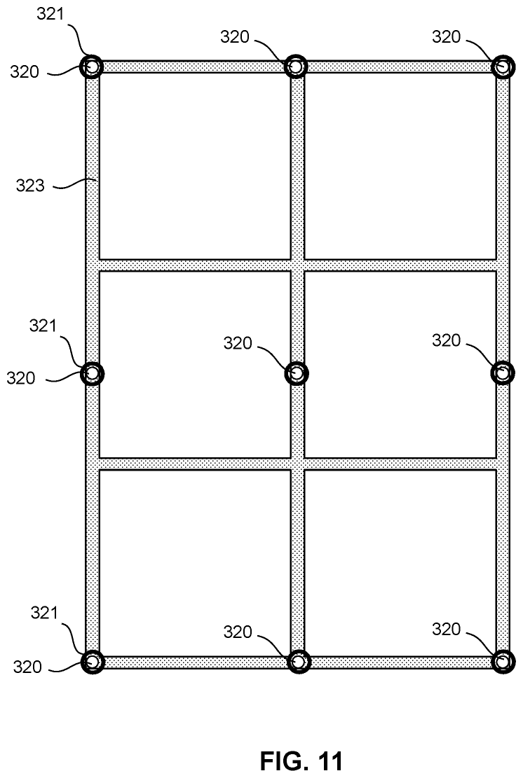

In the embodiment shown in FIGS. 5 and 11, the first plurality of fluid outlets 310 are located in at least a first elongate bar 308a comprising a plenum 306a in communication with the first plurality of fluid outlets 310. Each of the second plurality of fluid outlets 320 is individually disposed in a plurality of individual fluid nozzles 321. FIG. 14 shows an exemplary embodiment of a fluid nozzle 321 that may be used in accordance with one or more embodiments, showing a conically shaped fluid nozzle 321. However, other types of fluid nozzles may be utilized, such as flat nozzles, solid stream nozzles, hollow cone nozzles, fine spray nozzles, oval nozzles, square nozzles, etc. FIG. 11, which is a front view taken along line 11-11 of FIG. 5, shows the second plurality of fluid outlets 320 disposed in the plurality of fluid nozzles 321.

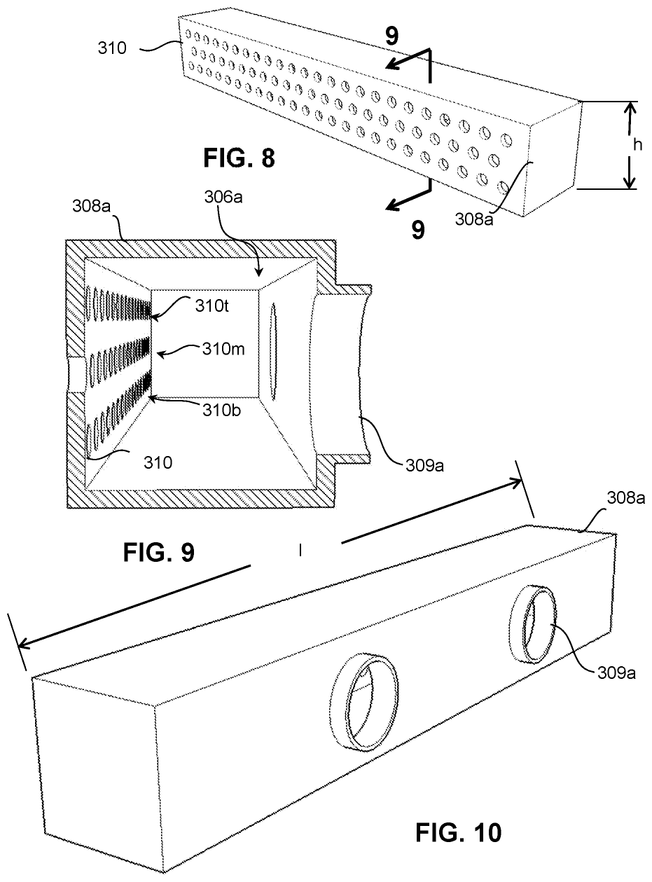

In the embodiment shown in FIGS. 5-11, the glass sheet processing apparatus 303 comprises a plurality of first elongate bars 308a, 308b, 308c, 308d, 308e and 308f spaced apart on a first frame 313, each of the first elongate bars 308a, 308b, 308c, 308d, 308e and 308f comprising a first plurality of fluid outlets 310 therein and a plurality of nozzles 321 spaced apart on a second frame 323 and in an opposed relationship with the plurality of first elongate bars 308a, 308b, 308c, 308d, 308e and 308f. In alternative embodiments, instead of the nozzles 321 spaced apart on the second frame 323, a plurality of second elongate bars 408a, 408b, 408c, 408d, 408e, 408f can be spaced apart on the second frame 323 instead of the nozzles 321, and the second plurality of bars comprise a plurality of second fluid outlets 420 in each of the second elongate bars 408a, 408b, 408c, 408d, 408e, 408f, with the plurality of second elongate bars 408a, 408b, 408c, 408d, 408e, 408f in an opposed relationship with the plurality of first elongate bars 308a, 308b, 308c, 308d, 308e and 308f such that the plurality of first elongate bars and the plurality of second elongate bars are separated by a gap “G”. The second elongate bars 408a, 408b, 408c, 408d, 408e, 408f can have a similar construction to the details of the elongate bar 308 shown in FIGS. 8-10 and can include a plenum and fluid inlets similar to that as shown in FIGS. 8-10.

While the embodiments shown and described herein show six elongate bars spaced on a frame the disclosure is not limited to a particular number, arrangement or spacing of elongate bars. The dimensions of the bars, the number of bars, the spacing of the bars and the arrangement thereof can be adjusted.

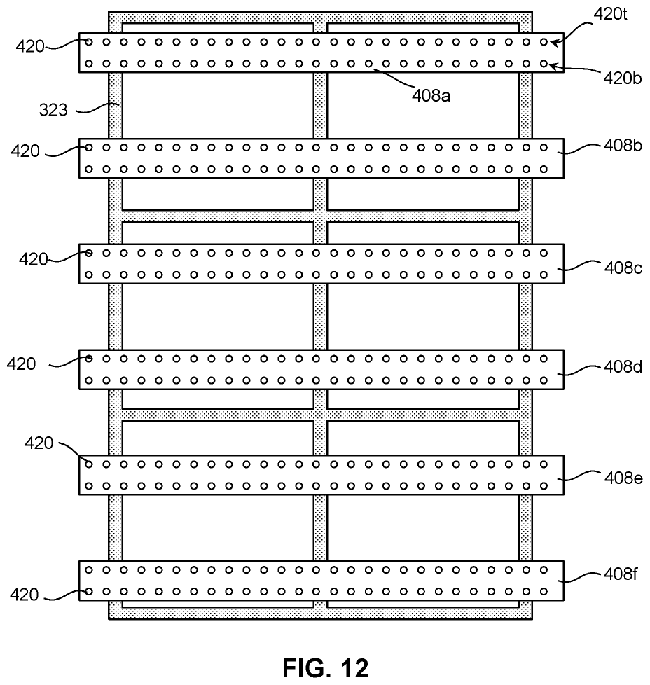

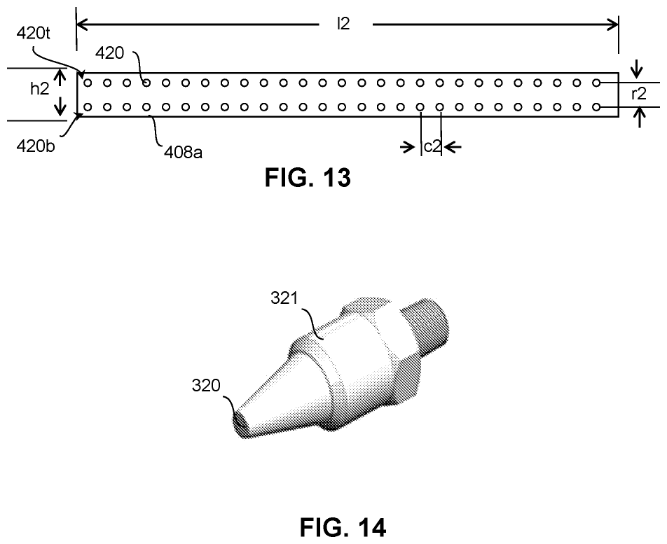

In a specific embodiment, the elongate bar 308a shown in FIGS. 6 and 8-10 (as well as elongate bars 308b-f) has a height “h” in range of from about 40 mm to about 60 mm and a length “l” 10% longer than the width “W” of the glass sheet being processed. For example, in some embodiments, the apparatus is configured to process a glass sheet having a width of 3.4 meters and height (transverse to width) of 2.8 meters and a thickness in a range of from about 0.01 mm to about 5 mm, such as from about 0.05 mm to about 3 mm, such as from about 0.05 mm to about 2 mm, such as from about 0.05 mm to about 1.8 mm, such as from about 0.05 mm to about 1.3 mm, and all ranges and subranges therebetween. In the specific embodiment, each of the plurality of first fluid outlets 310 have a diameter in a range of about from 0.5 mm to about 4 mm (for example, about 2 mm). The plurality of first fluid outlets in the embodiment shown comprise a top row 310t, a middle row 310m and a bottom row 310b of fluid outlets having a center-to-center spacing “r” between rows in a range of about 20 mm to about 30 mm (for example, about 25 mm), and a center-to-center spacing “c” of each opening within each row in a range of 20 mm to about 30 mm (for example, about 25 mm). In specific embodiments, the second elongate bar 408a shown in FIGS. 12-13 can be pressurized with a gas, which can be used to cool and reduce bow in a bowed glass sheet.

In some embodiments, the second plurality of fluid outlets 320 is disposed in a second elongate bar 408a comprising a plenum in fluid communication with the second plurality of fluid outlets. An embodiment of such an arrangement is shown in FIG. 12. In FIG. 12, there is a plurality of second elongate bars, 408a, 408b, 408c, 408d, 408e and 408f. The second elongate bars 408a, 408b, 408c, 408d, 408e and 408f have a different arrangement of fluid outlets, which will be discussed in more detail with respect to FIG. 13, than the first elongate bars 308a-f.

FIG. 13 shows a front view of the second elongate bar 408a shown in FIG. 12 with a different arrangement of a plurality of second fluid outlets 420 than the arrangement of the first fluid outlets 310 shown in FIGS. 6 and 8-9, showing the second plurality of second fluid outlets 420 including a top row 420t and a bottom row 420b. In the specific embodiment shown, elongate fluid bar has a height “h2” in range of from about 40 mm to about 60 mm and a length “l2” that is 10% longer than the width “W” of the glass sheet being processed. In the specific embodiment, each of the plurality of fluid outlets have a diameter in a range of about from 0.5 mm to about 4 mm (for example, about 1.4 mm). The plurality of fluid outlets in the embodiment shown comprise a top row 420t and a bottom row 420b of fluid outlets having a row-to-row spacing between rows “r2” in a range of about 20 mm to about 30 mm (for example, about 28 mm), with a center-to-center spacing “c2” of each opening within each row in a range of 20 mm to about 30 mm (for example, about 25 mm).

In some embodiments, the first plurality of fluid outlets 310 is movable from an open position at which the gap G is at a maximum to a closed position at which the gap is at a minimum. The first plurality of fluid outlets, which are disposed at the end of a nozzle or on a face of an elongate bar as described herein, are movable by the controller 335 described above with respect to FIG. 5. In some embodiments, both the first plurality of fluid outlets 310 and the second plurality of outlets 320 are movable from an open position at which the gap is at a maximum to a closed position at which the gap is at a minimum. In some embodiments, the second plurality of fluid outlets 320 is moveable by controller 345 as discussed above with respect to FIG. 5. In some embodiments, movement of the fluid outlets can be controlled by a single controller.

The plurality of first fluid outlets 310 can be supplied with a pressurized gas, such as air, hydrogen, argon or mixtures of air, hydrogen and argon. Air is readily available, inexpensive and can be provided via an industrial air compressor and delivered via a delivery line (e.g., by a hose or tubing) to the nozzles or to the elongate bars, which will cause the gas to be emitted from the first plurality of fluid outlets 310 and/or the second plurality fluid outlets 320 under pressure. The plurality of second fluid outlets can be supplied with pressurized gas such as air, argon, nitrogen or a mixture thereof. In some embodiments, one or both of the first plurality of fluid outlets and the second plurality of fluid outlets are supplied with a pressurized liquid such as water, so that pressurized water is emitted from at least one of the first plurality of fluid outlets and the second plurality of fluid outlets.

According to one or more embodiments, when a pressurized fluid (pressurized gas or pressurized liquid) exits the first plurality of fluid outlets 310 and the second plurality of fluid outlets 320, a first fluid cushion is formed between the first plurality of fluid outlets 310 and the first major surface 104a of the glass sheet 104 and a second fluid cushion is formed between the second plurality of fluid outlets 320 and the second major surface 104b of the glass sheet 104. In some embodiments, the pressurized fluid exits the first plurality of fluid outlets 310 and the second plurality of fluid outlets 320 at a pressure such that when a glass sheet comprising a bowed major surface having an amount of bow “B” is placed in the gap “G”, the pressurized fluid exiting the first plurality of outlets 310 and second plurality of outlets 320 exerts a sufficient stiffness-force between the first plurality of fluid outlets 310 and a first major surface 104a of the glass sheet 104 and the second fluid outlets 320 and the second major surface 104b of the glass sheet 104 to reduce the amount of bow “B” of the glass sheet 104.

For embodiments that utilize an elongate bar, in some embodiments, the bar should have a length that extends at least about 1 mm, at least about 2 mm or at least about 2.5 mm past the first vertical edge 153 and second vertical edge 155 of the glass sheet 104. In one or more embodiments, a ratio of surface area of the elongate bars facing a major surface (first major surface 104a or second major surface 104b) is at least about 0.15:1 of surface area of the elongate bar facing the major surface of the glass sheet, for example in a range of 0.15:1 to 0.75:1, or in a range of about 0.2 to about 0.75, or in a range of about 0.3 to about 0.75, or in a range of 0.4 to about 0.75. An apparatus having the aforementioned range of elongate bar surface area facing the major surface of the glass sheet provides sufficient fluid flow to flatten the glass sheet to reduce bow in the glass sheet.

In one or more embodiments, the force on a major surface of the glass sheet as created by the pressurized fluid through the elongate bars is controlled by the amount of flow/pressure applied to the elongate bars and transmitted through the first plurality of fluid outlets 310 and the second plurality of fluid outlets 320 in the elongate bar surface facing a major surface of the glass sheet. Acceptable results were obtained with elongate bars that were 50 mm in height and having a length that spanned 10% longer than the width “W” of the glass sheet. The elongate bars according to some embodiments can be constructed of a plenum chamber which allows even distribution of the fluid through a predetermined fluid outlet pattern. In some embodiments, the plenum is made from Ultra High Molecular Weight Polyethelyene (UHMW-PE) material but other thermal plastics or metals such as anodized aluminum could be used. Exemplary, non-limiting fluid opening patterns are shown in FIGS. 6 and 8-13.

When a liquid such as water is used to process the glass sheet to reduce the amount of bow, the capillary force of water may reduce the bow in a glass sheet. In a specific embodiment, a processing apparatus comprises a plurality of elongate bars pressurized (e.g., the elongate bars 308a-f in FIGS. 6 and 8-10) with a gas such as air directed at a major surface 104a and a plurality of elongate bars pressurized with water (e.g., the elongate bars 408a-f shown in FIGS. 12 and 13) at the opposite or second major surface 104b.

In one embodiment, during processing of a glass sheet having an amount of bow, the surfaces of a plurality of elongate bars (for example, the bars 408a-f as shown and described with respect to FIGS. 12-13) facing the second major surface 104b are initially spaced about 100 mm away from the second major surface 104b glass sheet at a starting position. The elongate bars are then pressurized with a fluid such as water and moved closer to the second major surface 104b of the glass sheet to within about 0.5 mm from the second major surface 104b. On the opposite side of the second major surface 104b of the glass sheet 104, a plurality of elongate bars similar to the elongate bars 308a-f, shown and described with respect to FIGS. 6 and 8-10, are positioned about 30 mm away from the first major surface 104a. The elongate bars 308a-f facing the first major surface 104a are pressurized with air, which causes the glass sheet 104 to flatten and cling to the second major surface 104b that is being subjected to water pressure while maintaining a 0.5 mm distance between the fluid outlets of the elongate bar pressurized with water and the second major surface 104b. When the elongate bars 308a-f facing the first major surface 104a are pressurized with air, the force of the pressurized air exiting the first plurality of fluid outlets reduces bow in the glass sheet 104. The glass sheet 104 is held against the water ejecting from the elongate bars dispensing water through the fluid outlets due to capillary force and pulled by Bernouli force of the water flowing through the elongate bars emitting water through the fluid outlets.

Suitable gas pressures for the elongate bars described above are in a range of from about 0.05 MPa to about 0.7 MPa, for example, in a range of from about 0.15 MPa to about 0.6 MPa, or in a range of rom about 0.015 MPa to about 0.5 MPa or in a range of about 0.15 MPa to about 0.4 MPa. When pressurized with liquid, suitable liquid pressures are in a range of about 0.05 MPa to about 0.6 MPa, for example, from about 0.10 MPa to about 0.5 MPa, or from about 0.15 MPa to about 0.4 MPa or from about 0.15 MPa to about 0.3 MPa. At these gas and liquid pressures, glass sheets exhibiting bow were processed such that the amount of bow was reduced in the processing apparatus. The fluid pressures (gas and liquid pressures) can be monitored in the supply lines using a digital pressure meter, and the flow rate can be monitored using a digital flow meter.

In an alternative embodiment (not shown), the plurality of first fluid outlets can be a plurality of first fluid nozzles similar to the nozzles shown in FIGS. 5 and 14 as the plurality of second fluid nozzles comprising the second plurality of outlets 320, and similar in arrangement to the arrangement shown on the second frame 323 in FIGS. 5 and 11.

Another aspect of the disclosure pertains to glass sheet processing system comprising a first apparatus comprising opposed fluid outlets defining a gap as shown in FIG. 5, with the first plurality of fluid outlets 310 opposed with the second plurality of fluid outlets 320 and defining gap “G.” The first plurality of fluid outlets 310 opposed with the second plurality of fluid outlets 320 are configured to direct pressurized fluid respectively on a first major surface 104a and a second major surface 104b of the glass sheet 104 to reduce bow “B” in the glass sheet 104. The system, according to one or more embodiments, further comprises a second apparatus in the form of a washer 203 such as the washer 203 described with respect to FIG. 2, the washer 203, located downstream from the first apparatus, comprising a plurality of liquid dispensing nozzles that can remove glass particles adhered to at least one of the first major surface 214a and the second major surface 214b of the glass sheet 104 after exiting the first apparatus.

In one or more embodiments of the system, in the first apparatus, the opposed fluid outlets comprise the first plurality of fluid outlets 310 adjustably spaced apart from the second plurality of fluid outlets 320 and defining a gap G sized to allow a glass sheet 104 comprising the first major surface 104a and the second major surface 104b defining a thickness T in a range of about 0.1 mm to about 3 mm to pass through the gap G, the first plurality of fluid outlets 310 directed at the first major surface 104a and the second plurality of fluid outlets 320 directed at the second major surface 104b when the glass sheet 104 passes through the gap G. In one or more embodiments of the system, the first apparatus comprises a pressurized fluid in communication with at least one of the first plurality of fluid outlets and the second plurality of fluid outlets and a controller that controls movement of at least one of the first plurality of fluid outlets 310 and the second plurality of fluid outlets 320 in a direction orthogonal to the first major surface and the second major surface of the glass sheet to increase or decrease the gap G. The controller can be the first controller 335 or the second controller 345 described with respect to FIG. 5. According to some embodiments, the system includes a third apparatus downstream from the second apparatus and positioned to receive the glass sheet from the second apparatus, the third apparatus comprising a gas knife to remove liquid from the glass sheet.

Another aspect of the disclosure pertains to a method of processing a glass sheet 104. The method comprises placing a glass sheet 104 between a first plurality of fluid outlets 310 adjustably spaced apart from a second plurality of fluid outlets 320 by a gap G so that the first plurality of fluid outlets 310 is directed at a first major surface 104a of the glass sheet and the second plurality of fluid outlets 320 is directed at a second major surface 104b of the glass sheet, and directing pressurized fluid exiting the first plurality of fluid outlets 310 at the first major surface 104a and exiting the second plurality of fluid outlets 320 at the second major surface 104b to cool the glass sheet 104.

In some embodiments of the method, the pressurized fluid exiting the first plurality of fluid outlets 310 forms a first fluid cushion between the first plurality of fluid outlets 310 and the first major surface 104a of the glass sheet 104 and the pressurized fluid exiting the second plurality of fluid outlets 320 forms a second fluid cushion between the second plurality of fluid outlets 320 and the second major surface 104b of the glass sheet 104. In one or more embodiments, the first major surface 104a and the second major surface 104b of the glass sheet 104 have an amount of bow prior to placing the glass sheet 104 in the gap G, and the first fluid cushion and second fluid cushion reduce the amount of bow. In one or more embodiments, the pressurized fluid exits the first plurality of fluid outlets 310 and the second plurality of fluid outlets 320 at a pressure to exert a sufficient stiffness-force on the first major surface 104a and on the second major surface 104b to reduce the amount of bow of the glass sheet. In some embodiments, the first fluid cushion comprises an air cushion and the second fluid cushion comprises an air cushion. In some embodiments, the first plurality of fluid outlets 310 are disposed in a first elongate bar comprising a plenum in fluid communication with the first plurality of fluid outlets 310 and the second plurality of fluid outlets 320 are disposed in a second elongate bar comprising a plenum in fluid communication with the second plurality of fluid outlets 320.

In alternative embodiments of the method, a plurality of first fluid nozzles comprise the first plurality of fluid outlets 310 and a plurality of second fluid nozzles comprise the second plurality of outlets 320. In some embodiments, the first plurality of fluid outlets 310 are disposed in a first elongate bar comprising a plenum in fluid communication with the first plurality of fluid outlets 310 and a plurality of second fluid nozzles comprise the second plurality of fluid outlets 320. The method according to one or more embodiments comprises moving the first plurality of fluid outlets 310 from an open position at which the gap is at a maximum to a closed position at which the gap is at a minimum.

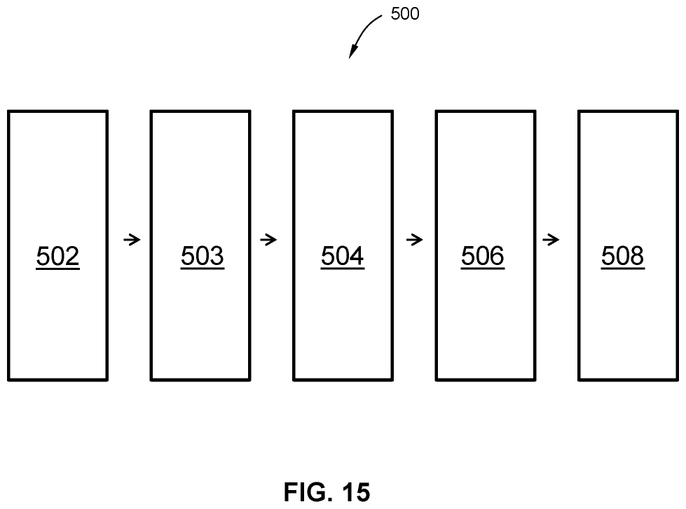

Methods of processing a glass ribbon 103 and a glass sheet 104 will now be described with reference to FIG. 15 which schematically illustrates a glass processing method 500 in accordance with various embodiments disclosed herein. The glass processing method 500 can begin with a separation step 502 where, for example, the glass sheet 104 can be separated from the glass ribbon 103 with the glass separator 149. In some embodiments, the glass sheet 104 can be separated from the glass ribbon 103 as shown in FIG. 1. In some embodiments, the outer portions 159 of the glass sheet 104 can be separated from the central portion 161 of the glass sheet 104.

After the separation step 502, the glass sheet may then be conveyed to subject to pre-processing in pre-processing step 503, for example in the apparatus shown and described with respect to FIGS. 5-14. In one or more embodiments, the glass sheet may be pre-processed remove bow and/or warp.

The glass processing method 500 may then proceed to a washing step 504 where debris generated during the separation step 502 can be removed with the washer 203 described with respect to FIG. 2. The glass processing method 500 can then proceed to a drying step 506 and an optional a measurement and inspection step 508.

In some embodiments, the method 500 can include separating a glass sheet 104 from the glass ribbon 103, and then washing the glass sheet 104 (e.g., in washer 203) to remove debris (e.g., separation debris, environmental debris) from a major surface (e.g., first major surface 214a, second major surface 214b) of the glass sheet 104. In some embodiments, washing can include a first stage of dispensing liquid (e.g., with first liquid dispenser 207 including first liquid nozzle 209) against a major surface (e.g., first major surface 214a, second major surface 214b) of the glass sheet 104 to at least one of remove debris and entrain debris in the liquid and a second stage of dispensing gas (e.g., with gas knife 217 including gas nozzle 219) against the first major surface 214a and the second major surface 214b of the glass sheet 104 to remove the liquid from the first major surface 214a and the second major surface 214b of the glass sheet 104.

In some embodiments, the glass sheet 104 can be oriented vertically and travel along a travel direction 221 during washing. In some embodiments, the gas can be dispensed during the second stage at a first angle “A1” relative to the travel direction 221 of the glass sheet 104 to direct the liquid downward in the direction of gravity. In some embodiments, washing can include rinsing the first major surface 214a and the second major surface 214b of the glass sheet 104 with a rinsing liquid (e.g., from second liquid dispenser 223 including second liquid nozzle 227) during the second stage prior to dispensing the gas against a major surface (e.g., the first major surface 214a and the second major surface 214b) of the glass sheet 104, and removing the rinsing liquid from the first major surface 214a and the second major surface 214b of the glass sheet 104 with a deflector 225 orientated at a second angle “A2” relative to the travel direction 221 of the glass sheet 104 to direct the rinsing liquid downward in the direction of gravity.

In one or more embodiments, prior to any one of the washing step 504, the drying step 506 and the optional measurement and inspection step 508, the glass sheet 104 may be subject to processing in the apparatus shown in FIG. 5 to subject the glass to a cooling step and/or a flattening step to reduce the amount of bow in the glass sheet 104 as described herein.

### EXAMPLE

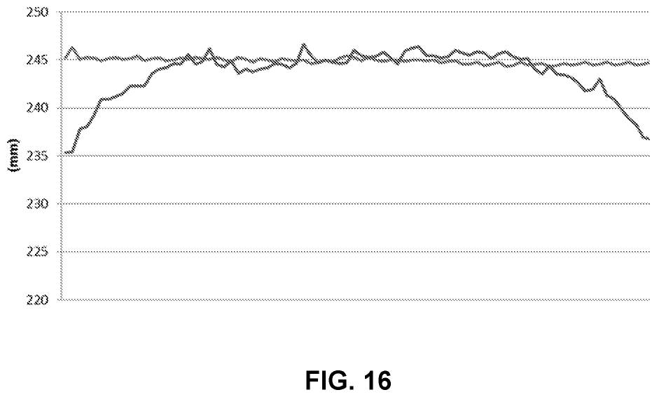

A first set of six elongate bars were arranged in a spaced relationship on a frame as shown in FIGS. 6-10. Each of the elongate bars had a height of 50 mm and a length that was 10% greater than the width “W” of the glass sheet being processed. Each of the first plurality of fluid outlets 310 had a diameter of about 2 mm. The first plurality of fluid outlets in the embodiment shown comprise a top row 310t, a middle row 310m and a bottom row 310b of fluid outlets having a center-to-center spacing “r” between rows of about 28 mm, and a center-to-center spacing “c” of each opening within each row of about 25 mm. The first set of bars was spaced apart 200 mm from second set of six elongate bars that were arranged in a spaced relationship on a frame as shown in FIGS. 6-10 (providing a gap G of 200 mm). The second set of elongate bars had the same dimensions and spacing of fluid outlets as the first set of elongate bars. A glass sheet was placed in the gap, approximately equidistant from the first set of bars and the second set of bars. The bars were then moved in a direction orthogonal to the major surfaces of the glass sheet at rate of 1 meter/second until a gap G of 24 mm was achieve, leaving 12 mm between the major surface of the glass sheet and the bars. The bars were then moved orthogonally toward the major surfaces of the glass sheet at 10 mm/s to a final gap G of 4 mm. The first set of elongate bars and second set of bars were pressurized with air at a pressure of 0.3 MPa. FIG. 16 shows the bow of the glass sheet as having an initial bow of about 12 mm, and after processing between the first and second set of elongate bars, the bow was reduced to about 2 mm.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a light source” includes embodiments having two or more such light sources unless the context clearly indicates otherwise. Likewise, a “plurality” or an “array” is intended to denote “more than one.” As such, a “plurality” or “array” of outlets includes two or more such elements, such as three or more such outlets, etc.

Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device that comprises A+B+C include embodiments where a device consists of A+B+C and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A glass sheet processing apparatus comprising:
a first plurality of fluid outlets adjustably spaced apart from a second plurality of fluid outlets and defining a gap sized to pass a glass sheet comprising a first major surface and a second major surface defining a thickness, the first plurality of fluid outlets directed at the first major surface and the second plurality of fluid outlets directed at the second major surface when the glass sheet is disposed in the gap;
a pressurized fluid source in communication with and supplying a pressurized fluid to at least one of the first plurality of fluid outlets and to at least one of the second plurality of fluid outlets; and
a controller that controls movement of at least one of the first plurality of fluid outlets and the second plurality of fluid outlets in a direction orthogonal to the first major surface and the second major surface of the glass sheet to increase or decrease the gap.

2. The glass sheet processing apparatus of claim 1, wherein the first plurality of fluid outlets are disposed in at least one first elongate bar comprising a plenum in fluid communication with the first plurality of fluid outlets, and wherein the second plurality of fluid outlets are disposed in at least one second elongate bar comprising a plenum in fluid communication with the second plurality of fluid outlets.

3. The glass sheet processing apparatus of claim 1, further comprising a plurality of first fluid nozzles including the first plurality of fluid outlets and a plurality of second fluid nozzles including the second plurality of fluid outlets.

4. The glass sheet processing apparatus of claim 1, wherein the first plurality of fluid outlets are located in at least one first elongate bar comprising a plenum in fluid communication with the first plurality of fluid outlets, the apparatus further comprising a plurality of fluid nozzles including the second plurality of fluid outlets.

5. The glass sheet processing apparatus of claim 1, wherein the first plurality of fluid outlets is movable from an open position at which the gap is at a maximum to a closed position at which the gap is at a minimum.

6. The glass sheet processing apparatus of claim 1, wherein the first plurality of fluid outlets and the second plurality of fluid outlets are movable from an open position at which the gap is at a maximum to a closed position at which the gap is at a minimum.

7. The glass sheet processing apparatus of claim 2, wherein the apparatus comprises a plurality of first elongate bars spaced apart on a first frame and a plurality of second elongate bars spaced apart on a second frame such that the plurality of first elongate bars and the plurality of second elongate bars are separated by the gap.

8. The glass sheet processing apparatus of claim 7, wherein the plurality of first elongate bars are pressurized with a first fluid and the plurality of second elongate bars are pressurized with a second fluid.

9. The glass sheet processing apparatus of claim 8, wherein the first fluid and the second fluid comprise air or wherein the first fluid comprises air and the second fluid comprises a liquid.

10. The glass sheet processing apparatus of claim 4, wherein the apparatus comprises a plurality of first elongate bars spaced apart on a first frame and a plurality of fluid nozzles such that the plurality of first elongate bars and the plurality of fluid nozzles are separated by the gap.

11. The glass sheet processing apparatus of claim 1, wherein when a pressurized fluid exits the first plurality of fluid outlets and the second plurality of fluid outlets to form a first fluid cushion between the first plurality of fluid outlets and the first major surface of the glass sheet and to form a second fluid cushion between the second plurality of fluid outlets and the second major surface of the glass sheet.

12. The glass sheet processing apparatus of claim 1, wherein a pressurized fluid exits the first plurality of fluid outlets and the second plurality of fluid outlets at a pressure sufficient to exert a stiffness-force between the first plurality of fluid outlets and the glass sheet and the second plurality of fluid outlets and the glass sheet to reduce an amount of bow of the glass sheet.

13. A glass sheet processing system comprising:
a first apparatus comprising opposed fluid outlets defining a gap, the opposed fluid outlets configured to direct pressurized fluid on a first major surface and a second major surface of a glass sheet to reduce bow in the glass sheet; and
a second apparatus located downstream from the first apparatus comprising a plurality of liquid dispensing nozzles that can remove glass particles adhered at least one of the first major surface and the second major surface of the glass sheet after exiting the first apparatus.

14. The glass sheet processing system of claim 13, wherein the opposed fluid outlets comprise a first plurality of fluid outlets adjustably spaced apart from a second plurality of fluid outlets and defining a gap sized to pass a glass sheet comprising a first major surface and a second major surface defining a thickness, the first plurality of fluid outlets directed at the first major surface and the second plurality of fluid outlets directed at the second major surface when the glass sheet is disposed in the gap.

15. The glass sheet processing system of claim 14, wherein the first apparatus further comprises a pressurized fluid source in communication with and supplying a pressurized fluid to at least one of the first plurality of fluid outlets and to at least one of the second plurality of fluid outlets; and a controller that controls movement of at least one of the first plurality of fluid outlets and the second plurality of fluid outlets in a direction orthogonal to the first major surface and the second major surface of the glass sheet to increase or decrease the gap.

16. The glass sheet processing system of claim 14, further comprising:
a third apparatus downstream from the second apparatus and positioned to receive the glass sheet from the second apparatus, the third apparatus comprising a gas knife to remove liquid from the glass sheet.

17. A method of processing a glass sheet comprising:
placing a glass sheet between a first plurality of fluid outlets adjustably spaced apart from a second plurality of fluid outlets by a gap so that the first plurality of fluid outlets is directed at a first major surface of the glass sheet and the second plurality of fluid outlets is directed at a second major surface of the glass sheet; and
directing pressurized fluid at the first major surface exiting the first plurality of fluid outlets and at the second major surface exiting the second plurality of fluid outlets to cool the glass sheet.

18. The method of claim 17, wherein the pressurized fluid exiting the first plurality of fluid outlets forms a first fluid cushion between the first plurality of fluid outlets and the first major surface of the glass sheet and the pressurized fluid exiting the second plurality of fluid outlets forms a second fluid cushion between the second plurality of fluid outlets and the second major surface of the glass sheet.

19. The method of claim 18, wherein the first major surface and the second major surface of the glass sheet have an amount of bow prior to placing the glass sheet in the gap, and wherein the first fluid cushion and second fluid cushion reduce the amount of bow.

20. The method of claim 19, wherein the pressurized fluid exits the first plurality of fluid outlets and the second plurality of fluid outlets at a pressure to exert a sufficient stiffness-force between the first plurality of fluid outlets and the first major surface and the second plurality of fluid outlets and the second major surface to reduce the amount of bow of the glass sheet.

21. The method of claim 19, wherein the first fluid cushion comprises an air cushion and the second fluid cushion comprises an air cushion.

22. The method of claim 18, wherein the first plurality of fluid outlets are disposed in a first elongate bar comprising a plenum in fluid communication with the first plurality of fluid outlets and the second plurality of fluid outlets are disposed in a second elongate bar comprising a plenum in fluid communication with the first plurality of fluid outlets.

23. The method of claim 18, wherein a plurality of first fluid nozzles comprise the first plurality of fluid outlets and a plurality of second fluid nozzles comprise the second plurality of fluid outlets.

24. The method of claim 18, wherein the first plurality of fluid outlets are disposed in a first elongate bar comprising a plenum in fluid communication with the first plurality of fluid outlets and a plurality of second fluid nozzles comprise the second plurality of fluid outlets.

25. The method of claim 18, further comprising moving the first plurality of fluid outlets from an open position at which the gap is at a maximum to a closed position at which the gap is at a minimum.
